(19) United States
(12) Patent Application Publication
(10) Pub. No.: US 2005/0215926 A1
(43) Pub. Date: Sep. 29, 2005

(54) Shower and massage system (II)

(76) Inventor: Dean Thrasher, North Manchester, IN (US)

Correspondence Address: RANDALL J. KNUTH P.C., 4921 DESOTO DRIVE, FORT WAYNE, IN, 46815, US

(21) Appl. No.: 11/008,429

(22) Filed: Dec. 9, 2004

Related U.S. Application Data
(60) Provisional application No. 60/528,094, filed on Dec. 9, 2003.

(51) Int. Cl. A61H 1/00

(52) U.S. Cl. 601/70; 601/69; 601/67; 601/46

(57) ABSTRACT

An aqueous facility such as a shower stall includes a stationary massager mounted in one of the shower walls. Alternately, the massager may be mounted in the backrest of a seat. The massager is positioned to facilitate ease of use by a user, who need only maneuver into proper engagement with the massaging contact surface, thereby facilitating a massaging action that avoids the need for manual manipulation of the massager unit. Placement of the stationary massager requires simple installation involving the formation of a receiving area such as a hole formed in the shower wall to receive the massager unit for mounting. The massager motor bracket can be maneuvered into mounting position by access from the front side or rear side of the shower wall.

### CROSS-REFERENCE TO RELATED APPLICATIONS

This application claims the benefit of U.S. Provisional patent application Ser. No. 60/528,094 filed on Dec. 9, 2003, by the same inventor as the present application, the contents thereof being incorporated herein by reference hereto.

### BACKGROUND OF THE INVENTION

1. Field of the Invention.

The present invention relates to a massaging application, and, more particularly, to the use of a fixed and stationary, but relocatable, massager unit in an aqueous environment.

2. Description of the Related Art

Massagers find various uses in fields such as physical therapy, rehabilitation, and other medical applications. In addition to the therapeutic value, massagers also provide simple relaxation to muscles and tissues. Typically, massagers are configured to require the user to manually manipulate the massaging head into contact with the body surface intended for treatment. For example, an extensible massager might be tethered using a recoilable connection that allows the massager to be removed from its holder and manipulated by the user into contact with various parts of the body.

However, one disadvantage of such a maneuverable massager is that individuals having limited movement may not be able to properly position the massager. For example, an elderly person or a post-operative patient recuperating from an arm or shoulder injury may not have the degree of limb freedom necessary to manipulate the massager.

Additionally, massagers oftentimes are add-on components to aqueous facilities such as shower stalls, which then requires the homeowner to install the device.

### SUMMARY OF THE INVENTION

According to the present invention there is provided a system including a fixed stationary, but relocatable, massager located in an aqueous environment. Additionally, there is provided a method of installing the massager in the aqueous environment.

In particular, in one form, there is provided a system including a fixed stationary massager located in an aqueous environment such as a pool, a hot tub, a shower, a sauna, a tub, and a hydrotherapy unit.

In various forms, the stationary massager may be configured at locations within the aqueous facility that facilitate massaging of various parts of the body; for example, a person's back, neck, torso, head, and limbs. For this purpose, the massager may be located at various positions depending upon the expected anatomical area receiving treatment. For example, the massager may be positioned at a wall, a seat backrest, a floor, and a sitting surface.

In one form, the massager is located within the aqueous facility by the use of a hole formed in a structure such as a shower wall. As a modular unit, the massager is mounted and fully contained in the space rearward of the hole so that the massaging contact surface is sufficiently accessible to a user.

In another form of the invention, there is provided a method of installing the massaging apparatus. In particular, for example, alternate installation strategies will permit the massager motor bracket to be maneuvered into mounting position by access from the front side or rear side of the shower wall.

The invention, in one form thereof, is directed to a system that includes an aqueous environment having a first portion, and a stationary massager. The massager is fixedly, but located in the aqueous environment at the first portion thereof.

The aqueous environment includes, but is not limited to, at least one of a pool, a hot tub, a shower, a tub, a sauna, and a hydrotherapy unit. Additionally, the first portion of the aqueous environment may define at least one of a wall, a seat backrest, a floor, and a sitting surface.

The system, in one form, further includes an actuator to selectively actuate operation of said massager. The actuator is suitably located to enable access thereof by a user in the aqueous environment.

The massager, in one form, further includes a contact portion accessible to a user. Additionally, the massager is preferably provided at a location suitable to enable a user to bodily engage the massager contact portion at a body location including at least one of the user back, neck, torso, head, and limbs.

The massager, in another form, further includes a motor assembly; a massaging surface operatively coupled to the motor assembly; and a bracket assembly housing the motor assembly.

The aqueous environment further includes a border structure defining an occupant area, such as the wall of a shower stall. In one form, the bracket assembly is coupled in mounting relationship to a front side of the border structure. Alternately, the bracket assembly may be coupled in mounting relationship to a rear side of the border structure. In another alternative, and preferred embodiment, as in FIG. 10, the system is attached to a member, such as an extruded rod, bar or other elongate shape, on which the massage pad contact assembly portion may be slid and then lockably immovably with a cam lock assembly.

The invention, in another form thereof, is directed to a system that includes an aqueous facility, and an immovable, but relocatable, massager located in the aqueous facility and having a massaging contact portion accessible to a user.

The invention, in another form thereof, is directed to a method of installing a massage unit in an aqueous environment. The aqueous environment has a border structure defining an occupant area. The massage unit is operatively associated with a bracket assembly suitable to housingly receive the massage unit.

According to the installation method, a definition step facilitates formation of an aperture in the border structure. The bracket assembly is maneuvered through at least a portion of the occupant area frontward of the border structure and through the aperture until the bracket assembly is located in a mounting position. The fully located bracket assembly is then attached to the border structure. The massage unit is then installed in the bracket assembly.

In one form, the attachment step further includes mounting the bracket assembly to a front side of the border structure facing the occupant area.

One advantage of the present invention is that the massager may be provided as a built-in unit requiring no installation by the user.

Another advantage of the present invention is that the stationary feature of the massager enables individuals with diminished or compromised physical ability to readily receive massaging treatment without any concern over their capacity to manipulate the massager into position.

Another advantage of the invention is that any aqueous facility can be readily adapted to incorporate the stationary massager without affecting the integrity of the environment.

A further advantage of the invention is that the massager finds wide use in a variety of application environments.

Another advantage of the invention is that the method of installation can be accomplished in alternate forms whereby the massager motor bracket can be maneuvered into mounting position by access from the front side or rear side of the shower wall.

Another advantage of the invention, one form thereof, is that the implementation utilizing front-side maneuvering and positioning of the motor bracket into mounting position avoids the need for conveying and guiding the bracket through a rear wall space behind the shower wall.

Yet another advantage of the present invention, in one form thereof, is that of locating the power module/motor behind the water enclosure, separate from the wall, thereby preventing or reducing sound cavitation or sound transmission to the tub or shower environment.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective diagrammatic view of a shower stall incorporating a massager apparatus, according to one form of the invention;

FIG. 2 is a diagrammatic cross-sectional view taken along lines A-A′ of FIG. 1, depicting an illustrative mounting arrangement for the massager apparatus;

FIG. 3 is a perspective diagrammatic view of another shower stall incorporating a massager apparatus, according to another form of the invention;

FIG. 4 is a perspective view of a bracket for use in mounting the massage apparatus of FIGS. 1 and 2;

FIGS. 5 and 6 are respective cross-sectional views of the bracket of FIG. 4 as installed in a working arrangement to position the massage apparatus of the invention in a shower stall;

FIG. 7 is a lateral perspective view of a motor bracket installation configuration, according to another form of the invention;

FIG. 8 is a front schematic view of the motor bracket of FIG. 7;

FIG. 9 is a front schematic view of a seal and bracket configuration, according to another form of the invention;

FIG. 10 is an exploded, perspective view of a preferred embodiment of the invention, utilizing a flex drive, or worm drive to provide rotational energy to the eccentric mounted behind the massage pad.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

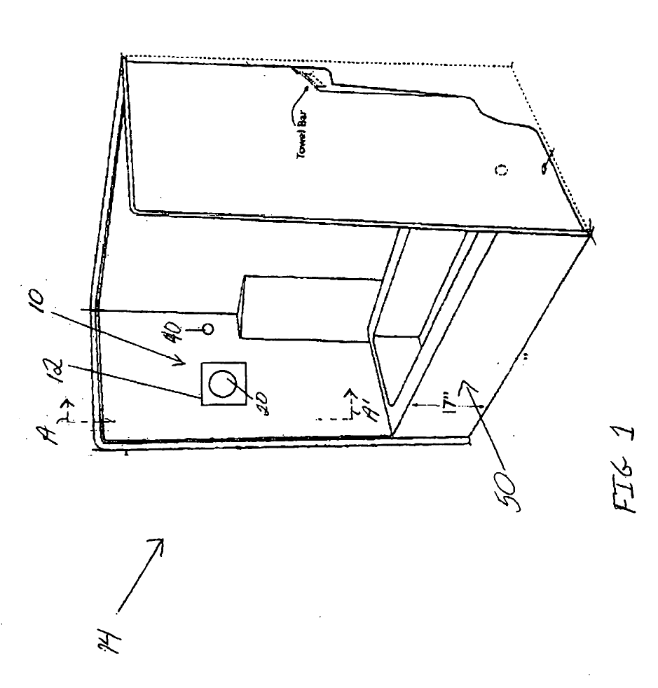

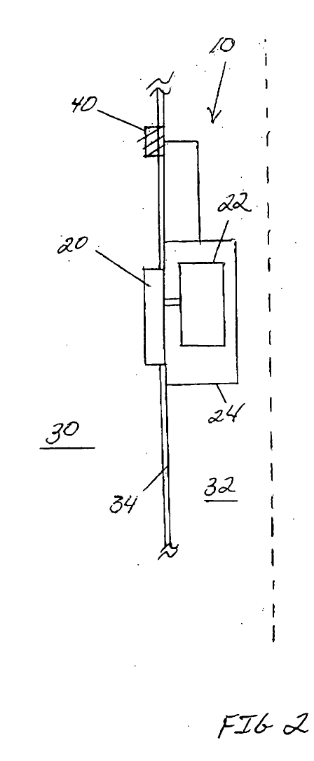

Referring now to the drawings and particularly to FIG. 1, there is shown an apparatus 10 employing a massager 12 in an aqueous environment such as a shower stall 14 (shown in partial perspective view), according to one form of the invention. FIG. 2 is a lateral cross-sectional view taken along lines A-A′ of FIG. 1.

Referring to FIGS. 1 and 2, the illustrated apparatus 10 includes a massager 12 having an exemplary massaging pad or contactable portion 20 that is operatively excited by a drive mechanism (generally illustrated at 22 in housing 24). For example, in one form, drive mechanism 22 may include a motor. Apparatus 10 may be constructed according to a conventional form known to those skilled in the art. The location of apparatus 10 is shown in relation to shower partition or wall 34 separating the shower or occupant area 30 from the interior wall space 32 lying behind wall 34.

As shown, massage apparatus 10 is mounted relative to shower wall 34 such that massage pad 20 sufficiently extends into occupant area 30 to enable ready accessability by a bather. To facilitate location of apparatus 10, a hole or other suitable aperture is formed in wall 34 to accommodate the positioning of housing 24 into wall space 32. In particular, the hole will be sufficiently sized to enable housing 24 to be fit therethrough in the manner indicated to facilitate its mounting.

Although not shown, any type of attachment or mounting mechanism known to those skilled in the art may be used to fixedly secure the location of apparatus 10. For example, any combination of brackets, nuts-bolts, and jigs can be used to align and mount apparatus 10 in its desired location. Additionally, suitable seals and gaskets known to those skilled in the art may be used in conjunction with apparatus 10 to seal the “wet” environment 30 from the “dry” environment 32. Appropriate electrical connections are made to provide power to apparatus 10, in a conventional manner known to those skilled in the art.

One advantage of disposing housing 24 in wall space 32 in the manner shown by FIG. 2 is to eliminate or minimize the possibility of water exposure to certain parts of apparatus 10, such as motor 22. Additionally, for aesthetic and functional purposes, it is important to optimize the degree to which the massage apparatus 10 projects into space 30, in order to conserve as much as possible the original size of occupant space 30. In particular, by locating housing 24 in the wall space 32 rearward of shower wall 34, the chief part of apparatus 10 that is present in occupant space 30 is its working section, namely, massage pad 20.

The activation of massage apparatus 10 may take any of various forms known to those skilled in the art. For example, in order to avoid the use of an electrical device exposed to a fluid environment, apparatus 10 may be activated by a non-electrical mechanism such as an air or pneumatic switch or push-button 40 in communication with motor 22. A user can simply depress button or switch 40 to activate/deactivate apparatus 10. However, any type of mechanism (including electrical) can be used to actuate operation of massage apparatus 10.

For example, a mechanism such as an infrared or motion detector can be used to detect the presence of an occupant within the shower or within a predetermined distance to the massage pad and automatically activate apparatus 10. In this manner, a user need not overtly interface or interact with an activation device. A remote control external to the shower may be used to control operation of the massage apparatus. An adjustable timer may be used to set the interval of use for the massager.

Examples of shower stalls and massagers may be found in the designs manufactured respectively by Front Line Mfg., Inc. of Warsaw, Ind. and Leesburg, Ind. and Morfam, Inc. of Mishawaka, Ind.

The massage apparatus of the invention may be located anywhere within the desired application environment. For example, referring to FIGS. 1 and 2, massage apparatus 10 is shown at an exemplary wall-mounted position amenable for use by a user who can readily lean into massage pad 20 and comfortably experience massaging at a back area. Depending upon the shower stall construction, a user may lean into the massage pad while sitting on a ledge, platform, or seat or while standing or squatting. It should be apparent that massage apparatus 10 may be provided at any other shower wall location at any suitable height. Additionally, a massage apparatus may be provided in one of the walls of tub 50. It would be mounted in a manner similar to the indicated shower-wall mounting.

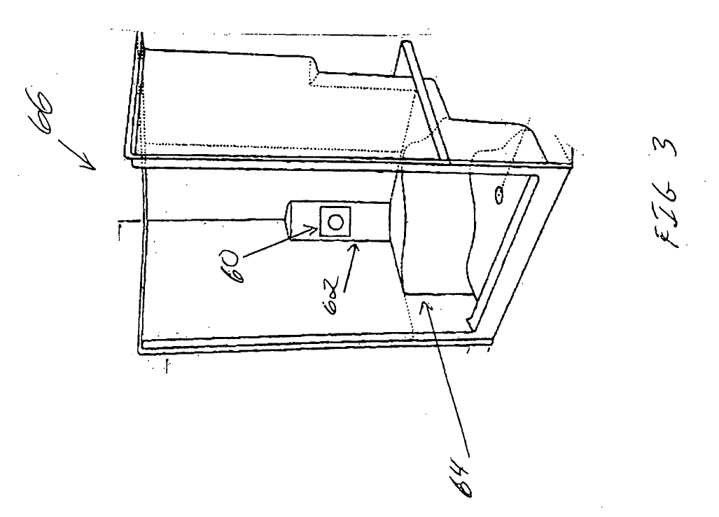

Alternately, in regard to FIG. 3, a massage apparatus 60 similar to apparatus 10 of FIGS. 1 and 2 may be configured at the backrest portion 62 of a seat structure 64 of a shower stall 66. Apparatus 60 would be mounted in a manner similar to the mounting of apparatus 10 in FIGS. 1 and 2. Additionally, a massage apparatus may be suitably positioned to provide massaging at a chamfered surface or corner in a shower or bath structure.

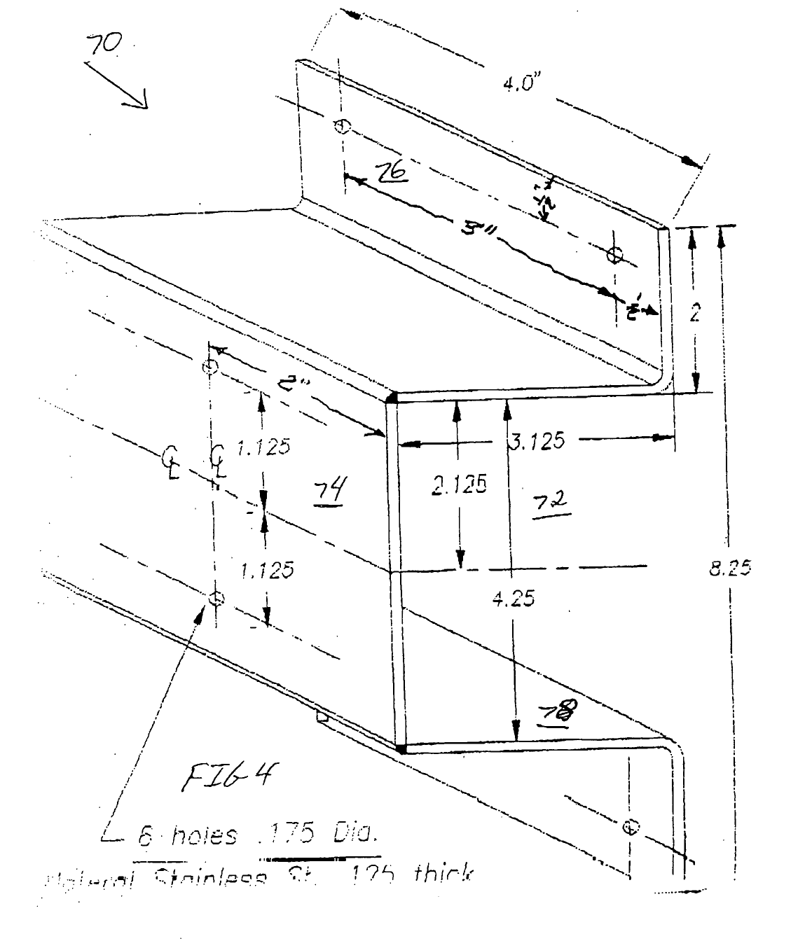

Referring to FIGS. 4-6, there is first shown in FIG. 4 an exemplary bracket 70 for use in positioning and mounting massage apparatus 10 of FIGS. 1 and 2, although it should be apparent that any other suitable mechanism may be used to accomplish attachment. The housing 24 (FIG. 2) of massage apparatus 10 would be located within space 72 defined by bracket 70 and mounted to rear portion 74. A pair of wing-type flanges 76 and 78 would facilitate attachment of bracket 70 to the shower wall.

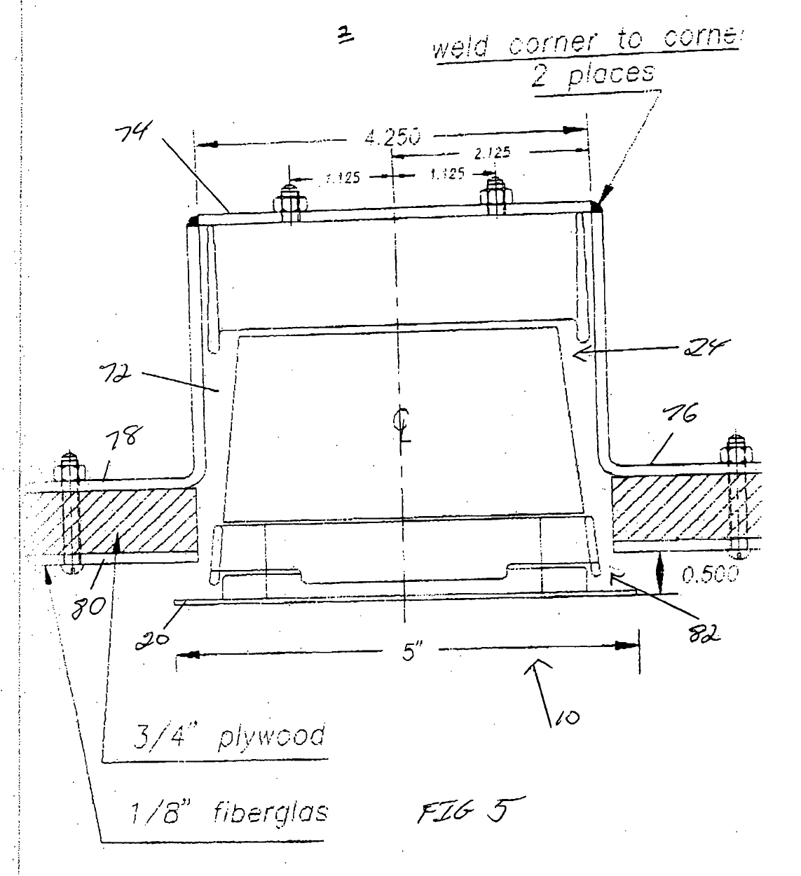

FIGS. 5 and 6 depict the mounted placement of massage apparatus 10 in conjunction with bracket 70, as attached to illustrative shower wall 80. As shown, a hole 82 has been formed in shower wall 80 to facilitate the installation of massage apparatus 10 (and perhaps bracket 70, if necessary).

In one exemplary construction, minimal design specifications are required for installation of the massager apparatus. For example, a single molded hole is prepared to receive the motor housing and a single hole is formed to receive the air switch. Preferably, the massager is delivered to an installation site pre-assembled, except for the motor bracket. As a pre-installation technique, it may be feasible and beneficial to pre-install a motor bracket and bolt a jig to the motor bracket. Various holes will be drilled through the shower wall that are required to bolt the unit in place and complete the installation. Accordingly, if such set-up work is completed for a fabricated shower stall prior to shipping, the stall may be delivered in a form ready for installation of the massager apparatus. In particular, at the installation site, it simply may be necessary only to situate the motor in the jig/bracket and make the appropriate connections. The massager apparatus may then be readily replaced or removed, if necessary.

In reference to FIGS. 5 and 6, the mounting arrangement depicted therein employs a method of installation in which the mounting fixture for securing the motor assembly (or other massaging mechanism) typically requires access into the backwall space rearward of the shower wall. For example, in FIG. 5, the motor bracket is located by bracket flanges 76 and 78 that are secured to a rearward portion of the backing material (e.g., plywood or drywall) behind the shower wall (e.g., fiberglass panels). In order to position bracket 70 in this manner, an installer would need to maneuver bracket 70 through the backwall space of the shower stall (e.g., interior space 32 in FIG. 2) until the bracket was placed into its appropriate mounting location.

This maneuvering or transport of the mounting structure (e.g., motor bracket) through the backwall space poses no difficulties if the installation is performed during construction or setup of the shower stall unit, for example, while a home is being built. However, for existing stall units, the required access into the backwall space may be difficult. It would therefore be advantageous to provide an installation methodology that permits the mounting process to be accomplished by access through the front wall, e.g., from the occupant area forward of the shower wall.

According to another form of the invention, there is provided an alternate method of installation in which the mounting apparatus for the massager is maneuvered into position frontwardly of the shower wall, as compared to the rearward maneuvering depicted in FIGS. 5 and 6.

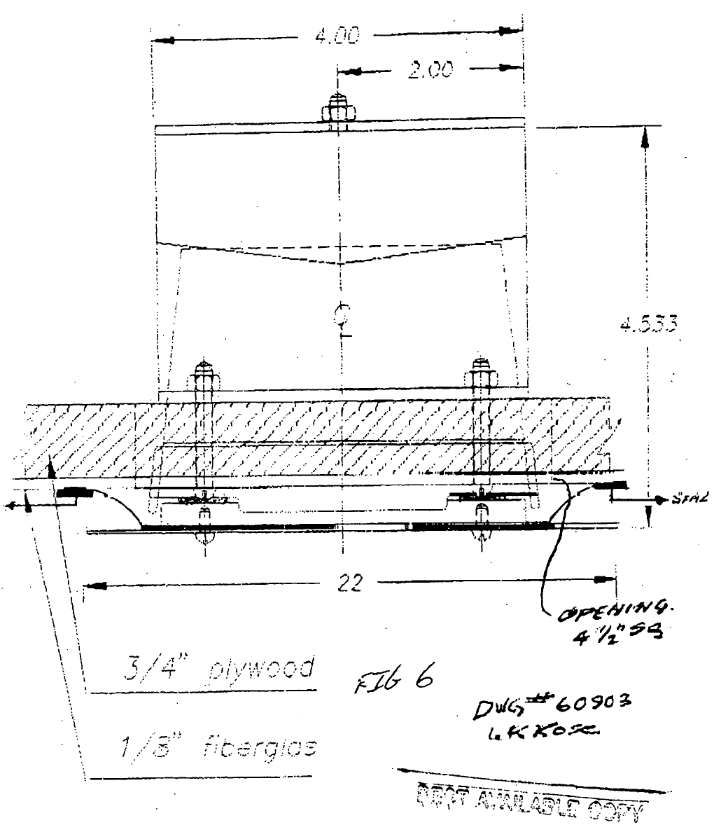

In particular, referring to FIG. 7, there is shown a lateral cross-sectional view of a forward-type mounting arrangement for installing a massager apparatus, according to another form of the invention.

In FIG. 7, there is shown a typical shower wall configuration including a fiberglass wall 100 and backing structure 102 generally defining the interface or boundary between the occupant area 30 and backwall space 32. According to the invention, suitable apertures or holes are formed through fiberglass wall 100 and backing 102 to receive bracket 104 as it is maneuvered into the indicated position from a position forward of fiberglass wall 100, namely, from occupant area 30. Bracket 104 is similar in structure and function to bracket 70 in FIGS. 4-6.

As shown, bracket 104 is secured to fiberglass wall 100 at forward-facing sections thereof at flanges 106 and 108. Notably, in comparison to FIGS. 5 and 6 where bracket flanges 76 and 78 are mounted to rearward-facing surfaces behind the shower wall (e.g., at the backing), the installation process in FIG. 7 permits the bracket flanges 106 and 108 to be mounted to forward-facing surfaces of fiberglass wall 100.

FIG. 7 further depicts motor 110 (shown in phantom) housed within bracket 104 in an operative configuration. In conventional manner, motor 110 is secured at a back end to bracket 104 via suitable means (e.g., screws 112) and at a front end to motor plate 114 via suitable means (e.g., screws 116). A massaging pad 120 is conventionally attached to motor plate 114.

In conventional manner, a protective boot 118 is disposed over the front end of motor 110 rearwardly of motor plate 114. An annular fluid seal 122 is employed to provide a sealing boundary between the wet environment 30 and the motor environment. In one form, the peripheral edge 124 of boot 118 is disposed or trapped between seal 122 and fiberglass wall 100 in a fluid-tight sealing arrangement, which may employ means such as exemplary screws 126 to facilitate the mounting arrangement of these parts.

One advantage of the mounting arrangement depicted in FIG. 7 is that the mounting apparatus can be conveyed or placed into position by maneuvering activities that occur entirely within the space forward of the shower wall, i.e., fiberglass wall 120. In this manner, the massaging apparatus can be more easily installed since it requires no access into the backwall area behind the shower wall. This front-mounting implementation greatly improves the ease of installation into existing shower stalls such as in homes, where rear wall access is difficult. The only rearward access would involve the need to run a power cable or other activation means to the motor, although minimal intrusion into the backwall area would be needed for this purpose.

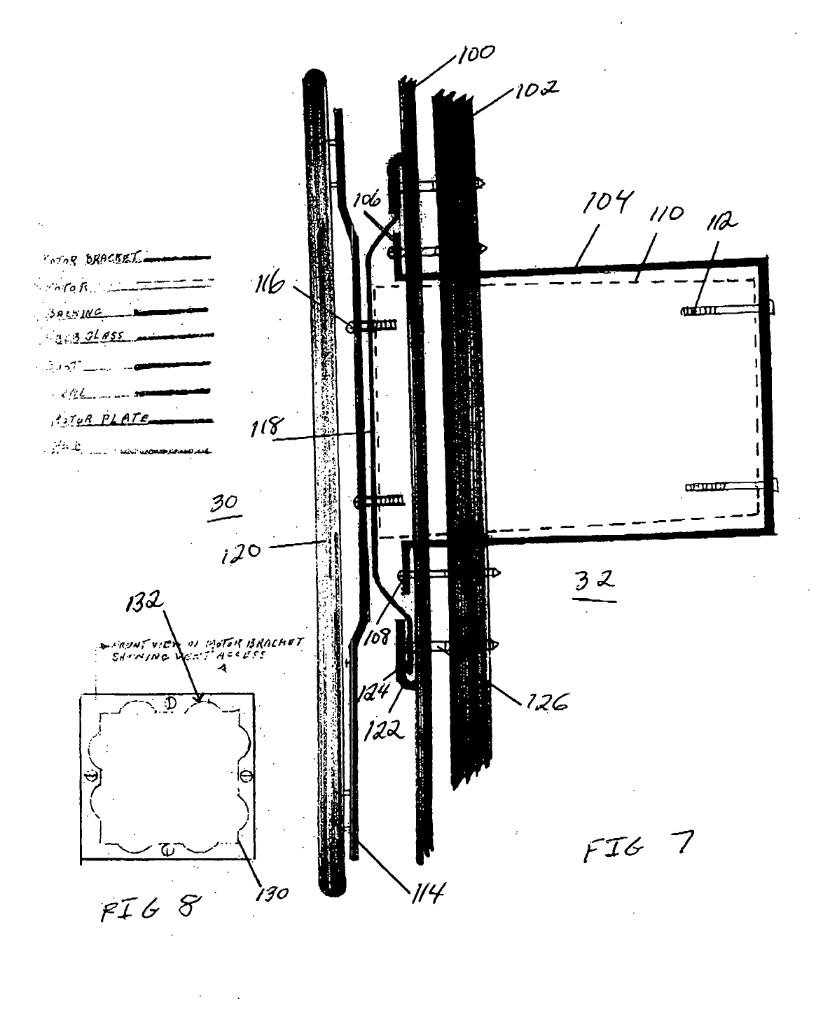

Referring to FIG. 8, there is shown a front schematic view of an illustrative design for the motor mount bracket 104 in FIG. 7, according to another form of the invention. As shown, the inner peripheral edge 130 of the bracket is provided with various outward-curving features 132 that define, in one form, access ports, apertures or vents. One use of such arcuate ports 132 is to enable user access behind the bracket or fiberglass wall 100 to facilitate desired rotational movement of the unit (e.g., bracket and/or motor) for positioning purposes or to facilitate attachment of the unit to the shower stall or backwall, e.g., to reach screws 112.

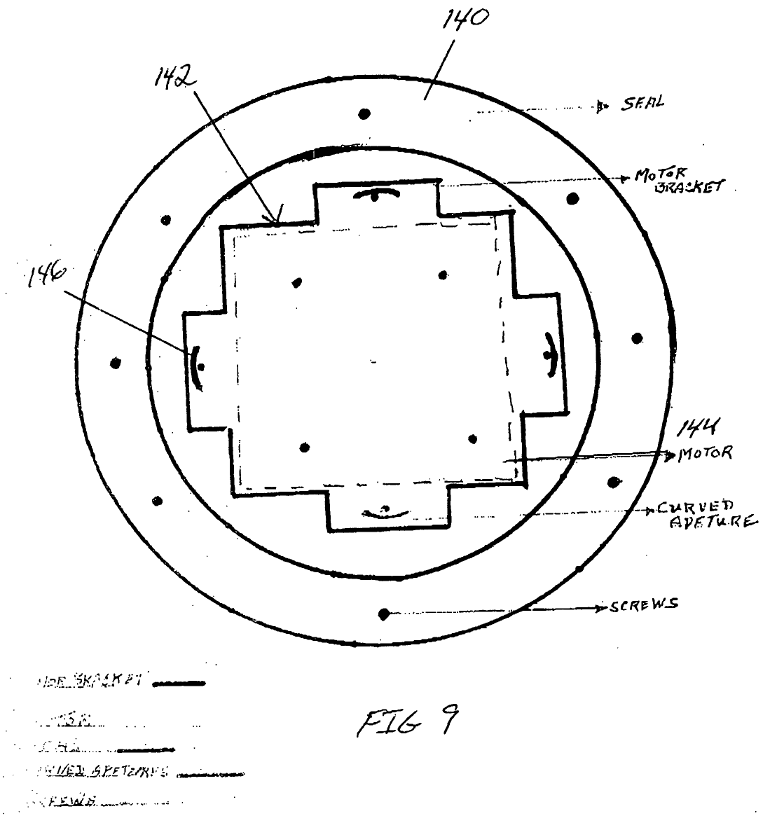

Referring to FIG. 9, there is shown a front schematic view of an illustrative seal and motor bracket arrangement for implementing seal 122 and bracket 104 in FIG. 7, respectively, according to another form of the invention. As shown, there is provided a seal 140 preferably provided in a circular form annularly disposed about motor bracket 142 that houses motor 144 (shown in phantom view) in an installed configuration. There is further provided a set of exemplary curved apertures 146 formed in bracket 142 that are comparable to apertures 132 in FIG. 8.

It may be considered that the massager apparatus of the invention, in one form thereof, can be implemented as part of a modular or remodeling kit that can be used in conjunction with various aqueous facilities that can readily be retrofit or adapted to incorporate the massager apparatus. Additionally, a plurality of individual discrete massaging units can be distributed throughout the aqueous environment to accommodate massaging of various body locations. For example, multiple massage units can be placed along a shower wall at different elevations to accommodate users of different heights. Additionally, in conventional form, a single massage apparatus may incorporate one or a plurality of individual massaging pads.

The massaging pad 20 may have various design features of conventional construction. For example, massaging pad 20 may be formed of a closed-cell foam construction. It should be apparent that any activation mechanism of passive and/or active form may be used to actuate massager 12.

It should be apparent to those skilled in the art that any type of conventional massage fixture may be used in the practice of the invention. For example, the massager may provide massaging action that includes, but is not limited to, oscillation, pulsation, rotation, and/or vibration. The massager may be fitted with a mechanism enabling a user to select the modality of treatment, if the massager is equipped to provide multiple types of massaging actions.

The depiction of a shower stall in FIG. 1 is provided for illustrative purposes only and therefore should not be considered in limitation of the invention, as it should be apparent to those skilled in the art that the invention may be used in any type of environment, preferably in conjunction with an aqueous facility. For example, the aqueous environments may include, but are not limited to, a pool, a hot tub, a shower, a tub, a sauna, and a hydrotherapy unit.

The massager may also be installed in modular or custom environments. For example, the massager may be integrated into a modular stand-alone shower stall that can be transported as a pre-fabricated, ready-for-use construction for installation in facilities such as recreational vehicles (RVs), sailing vessels, or other applications amenable to modular structures. Accordingly, the massager can be delivered to an end-user application as a built-in feature. The massager may be installed in permanent dwellings (e.g., homes) or mobile dwellings such as RVs, trains, or ships.

Alternately, existing structures such as bathroom tubs and showers can be adapted to incorporate the massager by appropriate installation techniques, such as mounting the massager in the wall space behind one of the bathroom walls enclosing the shower area. Additionally, in a structure such as a hot tub, the massager may be mounted directly to one of the hot tub surfaces. Optionally, to minimize the obtrusiveness of the massager within the occupant area, the hot tub or other similar structure could be provided with sealable apertures configured to receive the massager unit (for mounting purposes), so that the contact surface is the chief part of the massager unit that extends into the hot tub occupancy space.

Although the practice of the invention finds particular usefulness in “wet” environments (e.g., water or steam environments), it also may be possible to practice the invention in a “dry” environment, such as a doctor's office (e.g., a wall-mounted massage fixture).

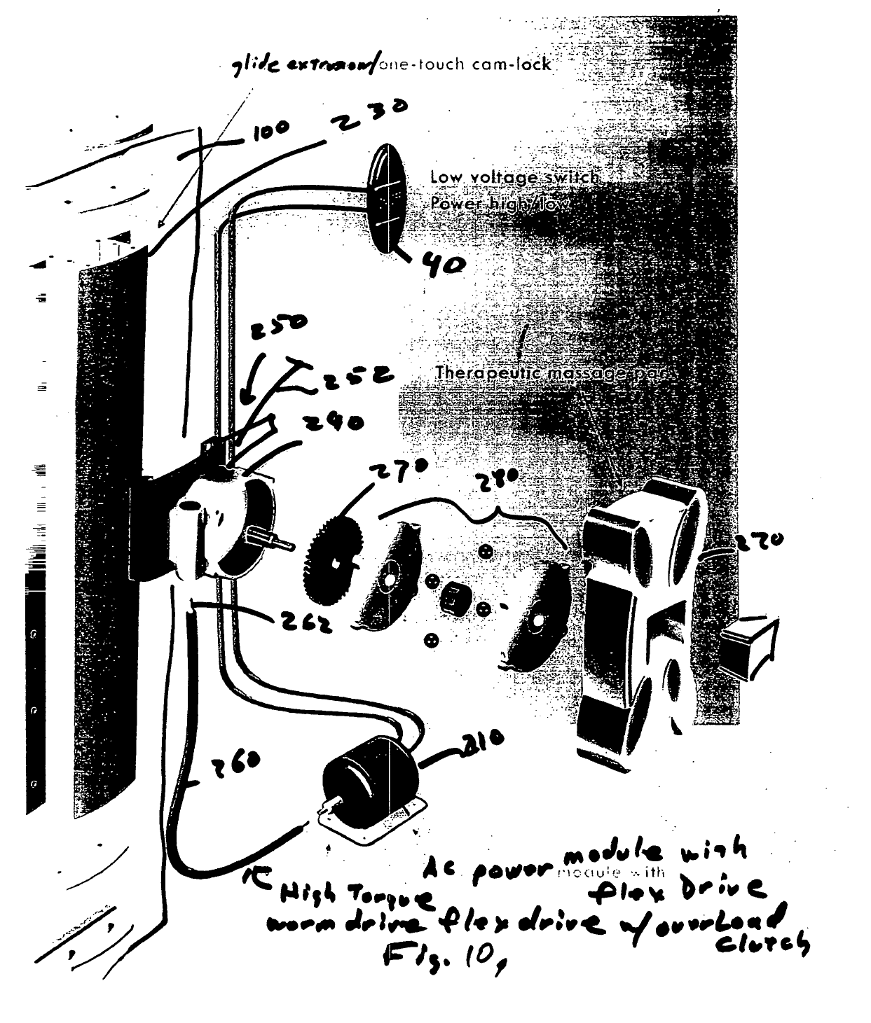

In another embodiment of the invention, as shown in FIG. 10, the system is utilized with a motor assembly/power unit 210 attached via a bracket and rubber motor mount pad (not shown) to a location behind, for instance the fiberglass wall 100. A member 230, is attached to the wall 100, to permit slidable, but lockable attachment of the mounting assembly 240 thereto. Member 230 is elongate in shape, and may take on the shape of a rod, square rod or other shaped on to which mounting assembly 240 may lockably slide. In one embodiment, member 230 may be formed from an extruded U shaped piece of aluminum.

Mounting assembly 240 is shaped to interlock and slide along member 230. As shown in FIG. 10, is a cam lock system 250 similar in form, structure and function as for example, the T Lock, one touch cam system, as available from 80/20, Inc, Columbia City, Ind. but other cam or hand setable, lockable attachment mechanisms from other manufactures can be utilized. The important feature is that mounting assembly 240 may be unlocked using a handle or other member 252, then slide along member 230, then re-locked into a desired position, by engaging cam lock system 250 by operation of handle 252.

Mounting assembly 240 is configured to connect to motor unit 210 via a worm drive or flex drive 260. Such flex drive 260 permits the location of either motor unit 210 or member 230 in numerous places and placements about a tub/shower stall/ or wall 100. Flex drive 260 terminates in a worm screw 262 that is located within mounting assembly and engages gear 270. Motor unit 210 when activated by switch 40, causes flex drive 260 to rotate. Rotation of the flex drive worm screw 262 causes corresponding, but geared rotation of gear 270.

A massage head assembly 280, such as containing an orbiting, ball bearing retaining apparatus, may then be connected to gear 270. Additionally or alternatively, massage head assembly 280 may contain an eccentric portion that would create vibratory oscillations during gear 270 rotation. A massage pad 220 is connect to massage head assembly 280.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A system, comprising:
an aqueous environment having a first portion; and
a massager, said massager being fixedly located in the aqueous environment at the first portion thereof.

2. The system as recited in claim 1, wherein the aqueous environment comprises at least one of a pool, a hot tub, a shower, a tub, a sauna, and a hydrotherapy unit.

3. The system as recited in claim 1, wherein the first portion of the aqueous environment defines at least one of a wall, a seat backrest, a floor, and a sitting surface.

4. The system as recited in claim 1, further comprises:
an actuator to selectively actuate operation of said massager.

5. The system as recited in claim 4, wherein the actuator being suitably located to enable access thereof by a user in the aqueous environment.

6. The system as recited in claim 1, wherein said massager further comprises a contact portion accessible to a user.

7. The system as recited in claim 6, wherein the massager having a location suitable to enable a user to bodily engage the massager contact portion at a body location including at least one of the user back, neck, torso, head, and limbs.

8. The system as recited in claim 1, wherein the massager further includes:
a motor assembly;
a massaging surface operatively coupled to the motor assembly; and
a bracket assembly housing the motor assembly.

9. The system as recited in claim 8, wherein the operatively coupled massaging surface is connected via a worm flex-drive.

10. The system as recited in claim 9, wherein the bracket assembly being coupled in mounting relationship to a front side of the border structure.

11. The system as recited in claim 9, wherein the bracket assembly being coupled in mounting relationship to a rear side of the border structure.

12. A system, comprising:
an aqueous facility; and
an stationary, but relocatable, massager located in the aqueous facility and having a massaging contact portion accessible to a user.

13. A method of installing a massage unit in an aqueous environment, the aqueous environment having a border structure defining an occupant area, the massage unit operatively associated with a bracket assembly suitable to housingly receive the massage unit, said method comprising the steps of:
defining an aperture formed in the border structure;
maneuvering the bracket assembly through at least a portion of the occupant area frontward of the border structure and through the aperture until the bracket assembly is located in a mounting position;
attaching the fully located bracket assembly to the border structure; and
installing the massage unit in the bracket assembly.

14. The method as recited in claim 13, wherein the attachment step further includes mounting the bracket assembly to a front side of the border structure facing the occupant area.
